(19) United States
(12) Patent Application Publication
(10) Pub. No.: US 2007/0076412 A1
(43) Pub. Date: Apr. 5, 2007

(54) Light source with light emitting array and collection optic

(75) Inventors: Gerald Harbers, Sunnyvale, CA (US); Serge J. Bierhuizen, Milpitas, CA (US)

Correspondence Address: PATENT LAW GROUP LLP, 2635 NORTH FIRST STREET, SUITE 223, SAN JOSE, CA, 95134, US

(73) Assignee: Lumileds Lighting U.S., LLC, San Jose, CA (US)

(21) Appl. No.: 11/242,300

(22) Filed: Sep. 30, 2005

(51) Int. Cl. F21V 9/00

(52) U.S. Cl. 362/231

(57) ABSTRACT

A light system includes a plurality of light emitting elements, such as light emitting diodes, arranged in an array. One or more light emitting elements are positioned in a center region of the array. The light emitting elements in the center region have superior performance, such as luminance and/or efficiency, relative to the remainder of the light emitting elements in the array. A second region that is outside the center region, i.e., farther from the center of the array, include a second group of light emitting elements that have superior performance relative to any additional light emitting elements in the array. The array may include additional regions farther from the center of the array that include light emitting elements with lower performance. A collection optic having an optical axis is optically coupled to the array such that the optical axis is located at approximately the center of the array.

### FIELD OF THE INVENTION

The present invention relates generally to light sources and more particularly to light sources that include light emitting elements arranged in an array and that use a collection optic.

### BACKGROUND

Light emitting diode (LED) devices have ever increasing applications. For example, optical systems that may use LEDs include projection systems (such as LCD and DLP projectors), theater lighting fixtures (such as gobos), fiber optic illuminators, or car head light fixtures. Such optical systems typically include a collection system that collimates the light to be efficiently transferred to a target. It is desirable, however, to continually improve the efficiency of optical systems that include LEDs, and light emitting elements in general.

### SUMMARY

A light system, in accordance with an embodiment of the present invention, includes a plurality of light emitting elements arranged in an array with superior performing light emitting elements, located at or near the center of the array and inferior performing light emitting elements located farther away from the center of the array. The array may include multiple groups of light emitting elements, where groups with light emitting elements having inferior performance are located farther from the center of the array than groups of light emitting elements having relatively superior performance. A collection optic having an optical axis is optically coupled to the array such that the optical axis is located at approximately the center of the array. The collection optic may be, e.g., a compound parabolic concentrator, a condenser lens, a rectangular angle transformer, a Fresnel lens, a lens using sections of total internal reflection surfaces, and any other appropriate device, and generally, has a higher transmission efficiency for rays emitted parallel to the optical axis than for rays emitted non-parallel to the optical axis.

### BRIEF DESCRIPTION OF THE DRAWINGS

FIG. 1 illustrates a light source that may be used with the present invention.

FIG. 2 illustrates a light source, such as that shown in FIG. 1, with an additional optical system between the collection optic and the target.

FIG. 3 is a graph illustrating the throughput efficiency of an optical system as a function of the angle θ between the ray and the optical axis.

FIGS. 4A and 4B illustrate a cross-sectional view and a top view, respectively, of an array of light emitting elements, which consisting of nine LED dice in a 3×3 arrangement.

FIG. 5 illustrates a top view of an array consisting of sixteen LED dice in a 4×4 arrangement.

FIG. 6 illustrates a top view of an array consisting of twenty-five LED dice in a 5×5 arrangement.

### DETAILED DESCRIPTION

In accordance with an embodiment of the present invention, a light system that includes an array of light emitting elements positions the best performing light emitting elements on or near the center of the array, which is aligned with the optical axis of the collection optic.

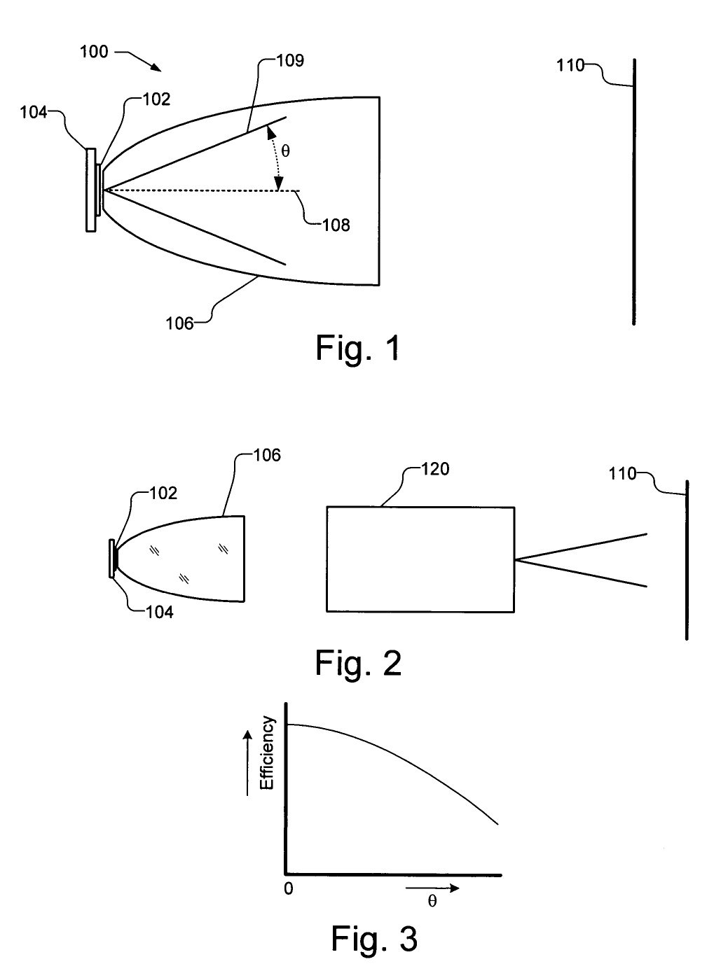

FIG. 1 illustrates a light source 100 that may be used with the present invention. Light source 100 includes an array 102 of light emitting elements, such as light emitting diodes (LEDs), mounted on, e.g., a submount 104. Light source 100 includes a collection optic 106, illustrated as a compound parabolic concentrator. Other or additional collection optics, however, may be used with the present invention if desired, such as a condenser lens, a rectangular angle transformer, a Fresnel lens, a lens using sections of total internal reflection surfaces (TIR), and any other appropriate device. In general, the compound parabolic concentrator is, e.g., a reflector with reflective walls that are at an angle with respect to the array to generally collimate the light emitted by the array 102 of light emitting elements. Alternatively, a straight wall tunnel might be used, at least for the first section, to achieve a better spatial distribution of light. The collimated light is used to illuminate target 110, which may be any object to be illuminated or highlighted. Light source 100 shown in FIG. 1 may be the complete light source system. Alternatively, as illustrated in FIG. 2, light source 100 may include one or more additional optical system 120 between the collection optic 106 and the target 110.

As illustrated in FIG. 1, the collection optic 106 includes an optical axis 108, which is aligned approximately at the center of the array 102. Also shown in FIG. 1 are illustrative rays 109 that enter the collection optic 106 from the array 102. The rays 109 are illustrated as having an angle θ with respect to the optical axis 108. FIG. 3 is a graph illustrating the throughput efficiency of an optical system as a function of the angle θ between the ray and the optical axis when the ray enters the system. The graph in FIG. 3 shows that as the angle θ increases, the efficiency of the optical system decreases. The maximum efficiency is found when the angle θ is zero, and is, thus, when the rays 109 travel close to or parallel with the optical axis 108.

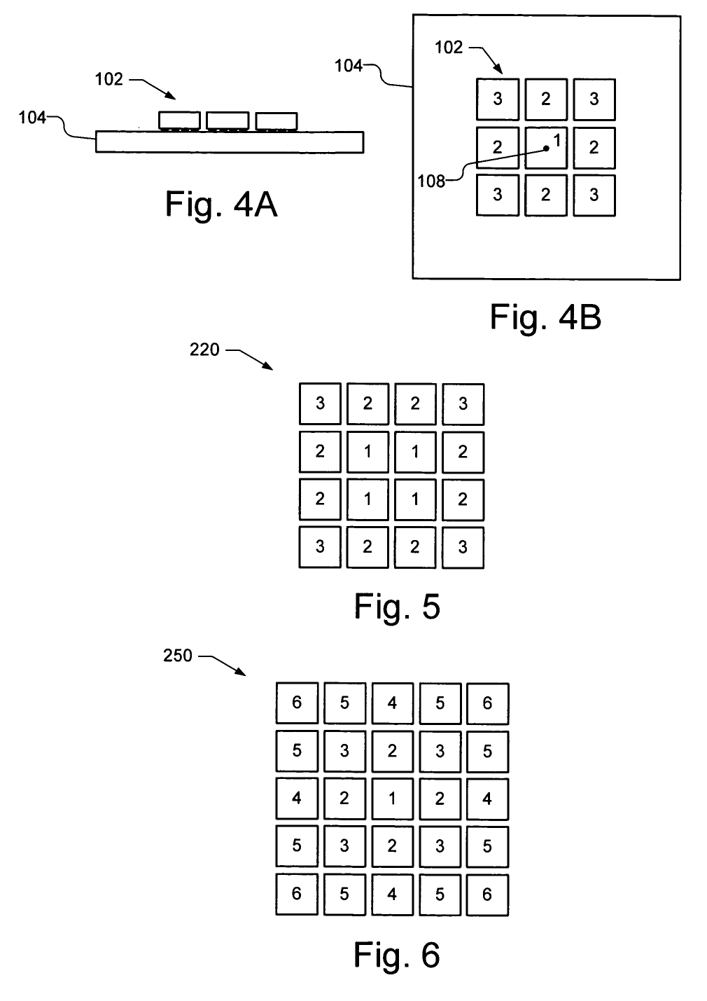

FIGS. 4A and 4B illustrate a top view and a cross-sectional view, respectively, of the array 102 of light emitting elements, which consists, e.g., of nine LED dice in a 3×3 arrangement. The LED dice are placed on a common submount 104, which has electrical connections for the LEDs. The light emitting elements may be any type of LED or other appropriate light element. For example, the LEDs shown in FIGS. 4A and 4B may be flip-chips, which have the n and p contacts formed on one side of the dies so that wire connectors are not needed. The submount 104 has corresponding contact pads that may be soldered to the dice contact pads. The submount 104 may be connected to a circuit board, a lead frame or other support assembly, and further connected to a heat sink if desired. The LEDs may be phosphor converted to produce, e.g., white light. Examples of forming LEDs, as well as different color phosphors, are described in U.S. Pat. Nos. 6,133,589; 6,274,399; 6,274,924; 6,291,839; 6,525,335; 6,576,488; 6,649,440; and 6,885,035, all of which are incorporated herein by reference. It should be understood, however, that any suitable LED, or other light emitting element, may be used with the present invention.

In practice, light emitting elements, such as LEDs, vary in performance, such as luminance and/or efficiency or any other parameter that is the key performance criterion for the system. By way of example, other parameters that may be a performance criterion include desired angular emission, color, polarization, or temperature dependence. As illustrated in the graph in FIG. 3, however, the efficiency of an optical system increases as the angle θ between the rays of emitted light and the optical axis decreases. Thus, the optical system has a higher transmission efficiency for rays emitted parallel to the optical axis than for rays emitted non-parallel to the optical axis. With the optical axis 108 of the collection optic 106 aligned with the center of the array 102, the light rays that travel close to or parallel with the optical axis 108 are generally produced at the central region of the array.

Accordingly, to increase efficiency of the light source 100, the superior performing light emitting elements are positioned in the center of the array 102 so that it is the superior performing light emitting elements that produce rays close to or parallel with the optical axis 108.

For illustrative purposes, three separate LED positions in the array 102 are labeled in FIG. 4B. As illustrated in FIG. 4B, a center region of array 102 is labeled as position 1, a second region of array 102 is labeled as position 2, and a third region of array 102 is labeled as position 3. The center region 1 in array 102 is located at the center of the array which is aligned with the optical axis 108. The second region 2 is orthogonally located relative to the center region 1 and is farther away from the center of the array 102 and the optical axis 108 than the center region 1. The third region 3 is located along the diagonal and is therefore farther away from the center of the array 102 than both the center region 1 and the second region 2.

In accordance with the present invention, the light emitting element with superior performance relative to the remainder of the light emitting elements in the array 102 is mounted at the center region 1 of the array 102. The four next best performing light emitting elements are mounted at the second region 2 of the array 102. Finally, the four light emitting elements with the worst performance are located at the position farthest from center, i.e., the third region 3 in array 102. Thus, the light emitting elements with the best performance are positioned on or near to the optical axis 108, while inferior performing light emitting elements are positioned farther away from the optical axis 108. In such a configuration, the light emitted approximately parallel to the optical axis from the best performing light emitting element, e.g., at the center region 1, is not reflected by the reflective walls of the collection optic 106.

Because the performance of each light emitting element must be known prior to mounting, the performance of each light emitting element is tested before the light emitting element is mounted to the submount 104. By way of example, the LED dice may be tested while in wafer form. Alternatively, the LED chips may be first mounted on an array of connected submounts, which are easily tested later singulated and mounted on the final submount 104. In one embodiment, a large batch of light emitting elements may be tested and organized based on performance into three groups; the best performers, the second best performers and the third best performers. The light emitting elements from the best performer group are mounted in the center regions 1 of different arrays, while light emitting elements from the second best performer group are mounted in second regions 2 and light emitting elements from the third best performer group are mounted in the third region 3.

It should be understood that the number of regions in the array 102 is illustrative. For example, the array 102 may be divided into a center region 1 and a secondary region that includes both positions 2 and 3. In this embodiment, the light emitting element with the best performance is mounted in the center region 1 and the remainder of light emitting elements is mounted outside the center region 1, i.e., in the secondary region 2, 3.

Moreover, the array used in the present invention may be larger than 3×2. For example, FIG. 5 illustrates an array 220 consisting of sixteen LED dice in a 4×4 arrangement. FIG. 5 includes labels for the locations of LEDs based on performance, similar to that shown in FIG. 4B. The four best performing LEDs are mounted in the center region indicated generally with the numeral 1, while the eight LEDs with second best performance are mounted in a second region indicated generally with the numeral 2. The four LEDs with inferior performance are mounted in the third region indicated generally with the numeral 3.

FIG. 6 illustrates another LED array 250 consisting of twenty-five LED dice in a 5×5 arrangement. The preference of LED placement is indicated by the numbers. In array 250 there are six unique positions. As discussed above, the LEDs are mounted in the array 250 with the best performing LEDs at the positions with the highest rank, i.e., closest to center, and the worst performing LEDs at the positions with the lowest rank, i.e., farthest from center.

Although the present invention is illustrated in connection with specific embodiments for instructional purposes, the present invention is not limited thereto. Various adaptations and modifications may be made without departing from the scope of the invention. It should be understood that the present invention may be used with larger LED arrays or with other array configurations, such as non-square arrangements, e.g., 2×3, or linear arrangements, e.g., 1×3. Therefore, the spirit and scope of the appended claims should not be limited to the foregoing description.

What is claimed is:

1. A light system comprising:
a plurality of light emitting elements arranged in an array, the array comprising:
a center region in which is positioned a first light emitting element, the first light emitting element having superior performance relative to the remainder of the light emitting elements in the array; and
a second region that is outside the center region, the second region containing a second group of light emitting elements having lower performance relative to the first light emitting element.

2. The light system of claim 1, wherein performance includes at least one of luminance, efficiency, angular emission, color, polarization, and temperature dependence.

3. The light system of claim 1, further comprising a collection optic having an optical axis, the collection optic being optically coupled to the array with the optical axis located at approximately the center of the center region of the array.

4. The light system of claim 3, wherein the collection optic has a higher efficiency for rays emitted parallel to the optical axis than for rays emitted non-parallel to the optical axis.

5. The light system of claim 3, wherein the collection optic is one or more of a condenser lens, a compound parabolic concentrator, a rectangular angle transformer, a Fresnel lens, and a lens using sections of total internal reflection surfaces.

6. The light system of claim 1, wherein the center region contains a single light emitting element.

7. The light system of claim 1, wherein the center region contains a plurality of light emitting elements, each of which having superior performance relative to the remainder of the light emitting elements in the array.

8. The light system of claim 1, wherein the array further comprises a third region that is outside the second region, the third region being more distant from the center region than the second region, the third region containing a third group of light emitting elements having lower performance relative to the first light emitting element and the second group of light emitting elements.

9. The light system of claim 8, the array being a square array, the second region being orthogonally located relative to the center region, and the third region being diagonally located relative to the center region.

10. The light system of claim 9, wherein the array is one of a 3×3 and a 4×4 array.

11. The light system of claim 8, the array further comprising:
a fourth region that is more distant from the center region than the third region, the fourth region containing a fourth group of light emitting elements having lower performance relative to the first light emitting element, the second group of light emitting elements, and the third group of light emitting elements;
a fifth region that is more distant from the center region than the fourth region, the fifth region containing a fifth group of light emitting elements having lower performance relative to the first light emitting element, the second group of light emitting elements, the third group of light emitting elements, and the fourth group of light emitting elements; and
a sixth region that is more distant from the center region than the fifth region, the sixth region containing a sixth group of light emitting elements having lower performance relative to the first light emitting element, the second group of light emitting elements, the third group of light emitting elements, the fourth group of light emitting elements and the fifth group of light emitting elements.

12. The light system of claim 11, wherein the array is a 5×5 array.

13. The light system of claim 1, wherein the array is a non-square array.

14. A light source comprising:
a collection optic having an optical axis; and
an array of light emitting elements optically coupled to the collection optic, the array having a center region that is aligned with the optical axis, the center region comprising a first light emitting element that has superior performance to light emitting elements mounted outside the center region of the array.

15. The light source of claim 14, wherein performance includes at least one of luminance, efficiency, angular emission, color, polarization, and temperature dependence.

16. The light source of claim 14, wherein the collection optic has a higher efficiency for rays emitted parallel to the optical axis than for rays emitted non-parallel to the optical axis.

17. The light source of claim 14, wherein the collection optic is one or more of a condenser lens, a compound parabolic concentrator, a rectangular angle transformer, a Fresnel lens, and a lens using sections of total internal reflection surfaces.

18. The light source of claim 14, the array having a second region that is more distant from the optical axis than the center region, the second region comprising a second group of light emitting elements having a superior performance relative to the remainder of the light emitting elements in the array, the array having at least one additional region that is more distant from the optical axis than the second region, the at least one additional region comprising the remainder of the light emitting elements in the array.

19. The light source of claim 14, the center region comprising a plurality of light emitting elements each of which is has superior performance relative to light emitting elements mounted outside the center region of the array.

20. A method comprising:
determining the performance of a plurality of light emitting elements; and
producing an array of light emitting element by mounting a first light emitting element at or near a center of the array, and mounting a second group of light emitting elements having lower performance relative to the first light emitting element farther from the center of the array than the first light emitting element.

21. The method of claim 20, further comprising optically coupling a collection optic having an optical axis to the array of light emitting elements, the optical axis being aligned approximately with the center of the array.

22. The method of claim 20, further comprising mounting a third group of light emitting elements having lower performance relative to the second group of light emitting elements farther from the center of the array than the second group of light emitting elements.

23. The method of claim 20, wherein performance includes at least one of luminance, efficiency, angular emission, color, polarization, and temperature dependence of the light emitting elements.

24. The method of claim 20, further comprising mounting a plurality of first light emitting elements near the center of the array, each of first light emitting elements having superior performance relative to the remainder of the light emitting elements in the array.

25. The method of claim 20, wherein the first light emitting element is mounted at the center of the array.
